(19) United States
(12) Patent Application Publication
(10) Pub. No.: US 2018/0322143 A1
(43) Pub. Date: Nov. 8, 2018

(54) Interactive Device With Three-Dimensional Display

(71) Applicant: F4, Paris (FR)

(72) Inventors: Fabrice Bernard, Paris (FR); Ludovic Perrine, Gentilly (FR); Jean-Marc Oury, Paris (FR); Bruno Heintz, Paris (FR)

(73) Assignee: F4, Paris (FR)

(21) Appl. No.: 15/739,479

(22) PCT Filed: Jun. 22, 2016
(86) PCT No.: PCT/FR2016/051532

§ 371 Date: Dec. 22, 2017

(30) Foreign Application Priority Data
Jun. 24, 2015 (FR) 1555807

(51) Int. Cl. G06F 17/30; G06T 15/00; G06T 17/05; G06F 3/0484

(52) U.S. Cl. CPC G06F 17/30241; G06T 15/005; G01C 21/3667; G06F 17/3089; G06F 3/0484; G06T 17/05

(57) ABSTRACT

An interactive device comprises a user interface (8) for defining display requests comprising at least location data and display data, a network interface arranged to issue a request for web page data corresponding to a display request, a memory (4) for receiving corresponding web page data, and a web interpreter (10) for displaying a web page from web page data. The web interpreter (10) comprises at least a WebGL interpreter and a 3D motor arranged to calculate, for given web page data comprising map data and object data, face data of at least one object associated with the object data, to group together said face data in face block data and transmit the face block data to the WebGL interpreter for the calculation of three-dimensional display data of said at least one object while maintaining a correspondence between at least some of the objects associated with the object data and the face data that corresponds thereto in the face block data. The web interpreter (10) is arranged to allow web page data to be displayed based on the map data and three-dimensional display data of the objects.

The invention relates to Web devices, and in particular to devices allowing interaction. More particularly, the invention relates to the field of mapping over the Internet.

Mapping over the Internet has for a long time been limited to the reproduction of paper maps in the form of images. This was inaccurate and consumed a great deal of bandwidth, and posed problems of relevance, since the images offered no simple means of scaling or of personalization.

Significant parties to the new technologies have modified this situation by proposing maps over the Internet that were lighter, whose scaling is adaptive, and that allow the user to rapidly navigate a given map. Note that, like the invention, these solutions are all of “pure Web” type, that is to say that a Web client (a browser or a smartphone application) interacts with a server to obtain the data, but stores nothing locally, outside of the cache. All the data originate from the server, in real time except for the data of the cache. This is crucial since, having regard to currently available bandwidths, the constraints on what it is possible to obtain in terms of visual effects are very strong if it is desired to maintain a fluid display.

These same parties have added onto these maps layers of information so as to add a little information, such as the site of certain businesses or monuments, etc. However, these are literally layers in the graphical sense of the term: the nature of the interaction is limited to the display of a text, the clickable area allowing this interaction is limited to an area of reduced size chosen in an arbitrary manner, and cannot for example relate to an entire property, or a park in a town. Efforts have also been made to afford a little realism by adding a three-dimensional view for certain buildings. But here again, these are purely graphical elements, devoid of interaction.

The invention aims to improve the situation. For this purpose, the invention proposes an interactive device, comprising a user interface for defining display requests comprising at least location data and display data, a network interface designed to issue a request for Web page data in correspondence with a display request, a memory for receiving corresponding Web page data, and a Web interpreter for displaying a Web page on the basis of Web page data, which Web interpreter comprises at least one WebGL interpreter and a 3D engine which is designed to calculate, for given Web page data comprising mapping data and object data, face data of at least one object associated with the object data, to group these face data together into data of face blocks and transmit the face block data to the WebGL interpreter for the calculation of three-dimensional display data for said at least one object while preserving a correspondence between some at least of the objects associated with the object data and the face data which correspond to them in the face block data, the Web interpreter being designed to make it possible to display Web page data on the basis of the mapping data and of the three-dimensional display data for said at least one object.

This device is advantageous since it makes it possible to have a representation of a mapping in three dimensions, with as many three-dimensional objects as necessary, each object being clickable individually and allowing a hitherto unknown interaction. Moreover, as the face data are calculated on the client side, it becomes possible to transmit a large quantity of three-dimensional objects, thereby making it possible to model all the properties in a town, and also the trees and other roadway details, as well as the networks which make it possible to achieve a degree of detail and of interactivity never achieved while preserving a fluid display.

According to diverse variants, the device can exhibit one or more of the following characteristics:
the memory stores only data of cache type,
the display data comprise zoom data, and the mapping data define a geographical environment substantially centered on a place designated by the location data, and whose extent depends on the zoom data,
the object data comprise building data comprising building location data, roof shape data, and height data,
the object data comprise relief data comprising location data, and altitude data,
the 3D engine calculates the face data by triangulation on the basis of the object data and of the zoom data,
the Web interpreter is designed to determine an identifier of object data of an object designated by a user via the user interface on the basis of the correspondence between some at least of the objects associated with the object data and the face data which correspond to them in the face block data,
the code of the 3D engine is received as display data upon the initialization of the device and/or during updates,
the 3D engine arranges the face block data in an object of Float32Array type, and
the device comprises hardware resources dedicated to display.

The invention also relates to an interactive display method comprising the following operations:
a. defining a display request comprising at least location data and display data,
b. issuing a request for Web page data in correspondence with a display request
c. receiving corresponding Web page data comprising mapping data and object data, and transmitting them to a Web interpreter comprising a 3D engine and a WebGL interpreter
d. calculating with the 3D engine face data of at least one object associated with the object data, and grouping these face data together into data of face blocks,
e. transmitting the face block data to the WebGL interpreter, while preserving a correspondence between some at least of the objects associated with the object data and the face data which correspond to them in the face block data, so as to calculate three-dimensional display data for said at least one object,
f. calling the Web interpreter with the mapping data and the three-dimensional display data for said at least one object so as to display Web page data.

Other characteristics and advantages of the invention will be better apparent on reading the description which follows, derived from examples given by way of nonlimiting illustration and derived from the drawings in which:

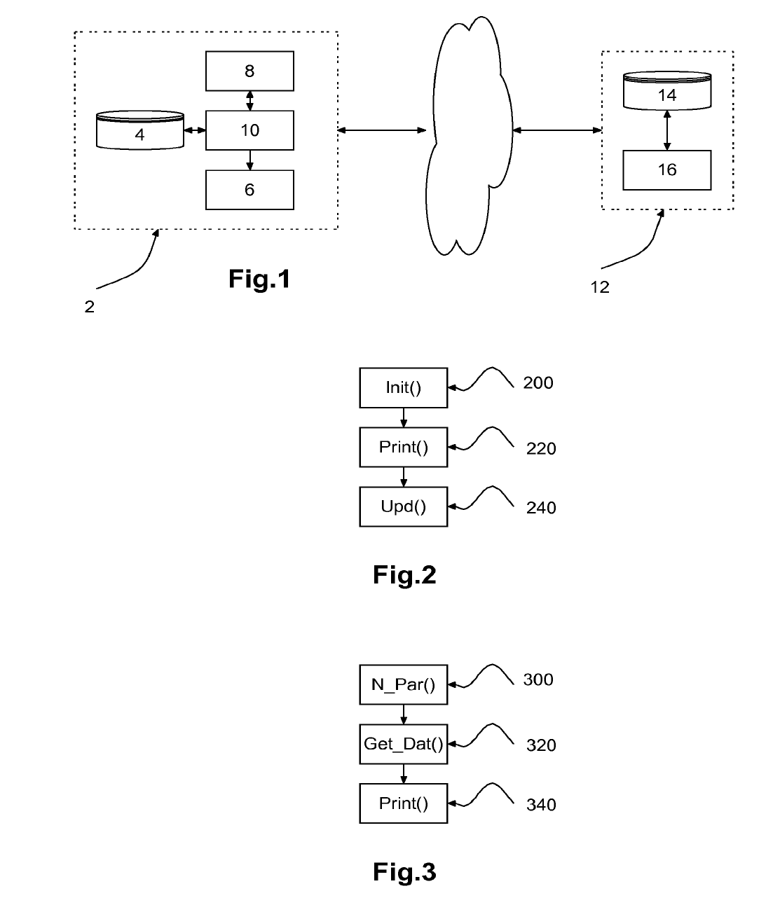

FIG. 1 represents a schematic diagram of a device according to the invention, in its operating environment,

FIG. 2 represents a schematic diagram of an operating loop of the device of FIG. 1, and

FIG. 3 represents a schematic diagram of an updating operation of FIG. 2.

The drawings and the description hereinafter contain, in essence, elements of definite character. They will therefore be able not only to serve to better elucidate the present invention, but also to contribute to its definition, if appropriate.

The present description is of a nature such as to involve elements susceptible to protection by author's rights and/or copyright. The owner of the rights has no objection to the identical reproduction by anyone of the present patent document or of its description, such as it appears in the official dossiers. As for the rest, he fully reserves his rights.

FIG. 1 represents a generic diagram of an interactive device 2 according to the invention in its environment.

The example described here finds a particularly beneficial application in the field of on-line mapping. However, the invention finds its application in any situation involving a display in three dimensions involving interactivity with the user in an “any server”, or “any stream (streaming in english)”, context, that is to say that all the data arise from a server, the device storing nothing locally (including the JavaScript code of the 3D engine in the example described here) apart from the cache. This application is particularly suitable for Web use, but will be able to be used in application form for smartphones for example, in a format other than a Web page. In this case, the application will be able to store the code data of the 3D engine for example, but will still not aim at storing other data than the cache, that is to say that the data stored do not persist.

The device 2 comprises a memory 4, a display 6, a user interface 8, a network interface (not represented) and a Web interpreter 10.

The memory 4 can be any means for storing information: Flash memory, RAM memory, a hard disk, a connection to remote storage or in the cloud, etc. Within the framework of the invention, the memory 4 serves to store the data with a view to processing. As mentioned above, it is not intended that the data of the memory 4 should persist, except to serve as cache whose duration of validity is programmed and limited. Indeed, the invention envisages a real-time application where all the data are obtained from the server, without prior local storage.

The display 6 can be any conventional display of the screen, video projector, projection glasses type, etc. The user interface 8 allows the user of the device 2 to choose the map display parameters as well as the site that he wishes to view.

The display parameters may pertain in a non-restrictive manner to the latitude and the longitude, the zoom level, the angle of the view, the orientation. These parameters are conventional in this type of application. The invention also proposes other, so-called “personalization” display parameters.

Indeed, in the known applications, it is possible to activate or to deactivate the display of certain elements. However, this entails only displaying or not displaying the corresponding information layers. It does not entail making it possible to personalize the display of a restricted set of objects, for example. Besides, it is not possible to speak of “objects” in the prior art applications. These entail simple mappings, optionally furnished with three-dimensional displays, but not customizable. On the contrary, the invention makes it possible to render each element of the mapping independent, as computerized object.

The Web interpreter 10 can be effected by any browser implementing HTML, JavaScript and WebGL. As will be seen in what follows, the Web interpreter 10 comprises a WebGL interpreter and a 3D engine (neither of which is represented). In the example described here, the user accesses the mapping by way of a Web page. This Web page contains at one and the same time HTML code, JavaScript code and WebGL code. The JavaScript code defines the 3D engine, which receives object data to be represented on the map portion requested by the user, and transforms these object data into face data. The face data are transmitted to the WebGL interpreter which interacts with the hardware resources of the device 2 to calculate the data to be displayed properly speaking.

As mentioned previously, all the data are obtained from a server 12 which comprises a memory 14 and an engine 16. The memory 14 is similar to the memory 4, except in that it stores all the information useful to the operation of the device 2 (in contradistinction to the memory 4 which stores almost exclusively cache).

The engine 16 is an element which receives the Web page data requests of the device 2. As was seen above, on the basis of the data received by the user interface 8, the device 2 defines a request for mapping display on the basis of the location data and of the display data. These data together define a geographical area. On the basis of this geographical area, the device 2 issues a request for Web page data to the server 12, and the engine 16 selects from the memory 14 the mapping data as well as the data of the objects which correspond to this request.

In the example described here, the mapping data of the memory 14 are stored in the form of tiles (“tiles” in english) as several levels of details. Thus, each tile is decomposed into four sub-tiles when the zoom level increases, and vice versa, etc. In the example described here, the mapping data contain for each tile the list of the objects which are associated therewith. As a variant, the data of objects could contain data indicating the tiles to which they are tied.

In the example described here, the identification of the tiles is implicit, that is to say that the device 2 can determine which tile data the server 12 is to be asked for via the Web page data request. Thus, the latter is a pure request for resources, and the server 12 does not develop any “intelligence”. As a variant, the Web page data request could be more abstract and contain the location data and the display data, and the server 12 would take charge via the engine 16 of determining the relevant tile data.

The data of the objects comprise, in the example described here, data making it possible to define in an abstract manner the three-dimensional display of these objects. Thus, for a building, the object data comprise data defining the footprint, the shape of its roof, and building height data. A building may exhibit several heights. Thus, when the 3D engine calculates the face data of a building, it proceeds by “raising” a contour corresponding to the footprint of the building to the height of the corresponding object data, and by calculating the triangles defining each of the faces of the thus-defined object. Another way of seeing this is to consider that a building is “extruded” through its footprint over its height. For a ground or a relief, one proceeds in a similar manner—on the basis of the tiles of the mapping data, a mesh of the ground is produced by triangulation. This mesh can be used to represent reliefs using object data of relief data type, which comprise location data making it possible to indicate the tile to which they correspond, and altitude data for indicating the height of the relief. When relief data are received, the vertices of the triangles of the tiles corresponding to the corresponding location data are raised to the height designated by the corresponding altitude data. The objects may also be intangible, and designate for example a bus line or subway line, or a water or electricity distribution network etc.

Advantageously, but optionally, as a function of the Web page data request, the engine 16 can select the data of objects as a function of a value indicating their size. Thus, if the zoom is very distant, the engine 16 returns only the details whose size is relevant having regard to the resolution of the map reproduced. And as soon as a user zooms, the engine 16 will dispatch the object data whose size has rendered them relevant having regard to the resolution sought. This presents the advantage of making it possible to control the device side downloading and processing load, and also to improve the visual experience: as a user zooms, the world becomes clearer before their eyes.

FIG. 2 represents a schematic diagram of an operating loop of the device of FIG. 1.

In an operation 200, the device 2 carries out the initialization of the display of the mapping. Accordingly, the location data and the display parameters are obtained on the basis of the user interface 8, and the device 2 implements the network interface so as to issue a display request to the server 12 with these data. In response, the server 12 issues data comprising the code of the 3D engine, as well as the mapping data and the corresponding object data. In the following exchanges, the code of the 3D engine is no longer transmitted.

In an operation 220, the device 2 receives the mapping data and the object data, as well as the code of the 3D engine. On the basis of these data, the Web interpreter 10 displays for example by priority the mapping data, which give the user a rapid view of the “map background”. At the same time, the 3D engine processes the object data to calculate the corresponding face data. The face data of each object are grouped together, and input into a face data block, by means of a memory block of 32-bit value array (or “Float32Array”) type used by the WebGL interface, hereinafter Buffer32. The Buffer32 is a conventional tool in WebGL which serves to transmit a request to calculate 3D display data to a hardware resource on the basis of face data defined in the Buffer32. The WebGL interpreter transmits the Buffer32 containing all the face data to the hardware resource of the device 2 for calculation of the data for three-dimensional display of the object data. Each Buffer32 can contain data relating to 65536 vertices of triangles. When a Buffer32 is “full”, the 3D engine instantiates another one, while safeguarding the correspondences between the data of each Buffer32 and the objects to which they correspond. As a variant, the Buffer32 could be effected with another type of array of values. The face data can comprise data defining vertices, faces, or else texture mapping information about the triangles.

Simultaneously, the Web interpreter 10 preserves a correspondence between the face data grouped together for each object of the Buffer32 and the identifiers of the corresponding objects. Thus, if a user wants to select an object, he clicks with the mouse on a site of the latter on the screen (or some other means for designating a site on the screen such as the JavaScript “onMouseOver” event). In response, the WebGL interpreter issues a “ray picking” type request, which returns the face, in the Buffer32, which has been designated by the click, and, on the basis of this correspondence, the Web interpreter 10 is capable of knowing which object has been clicked or designated, and of offering the user a menu of options for making requests specific to this object or to a class of objects corresponding thereto from the server 12, or else displaying this object in a particular manner As a variant, schemes other than ray picking could be used to determine the face which lies under the mouse (for example the rendition at a single point of the scene with coloring of the faces on the basis of their identifier and identification of the face on the basis of the color of this point).

This characteristic is fundamental for two reasons:
the concatenation of a considerable assembly of face data in a few Buffer32s makes it possible to carry out display of a large quantity of objects without losing in terms of fluidity. This was impossible before the invention; and
the maintaining of the correspondence between the objects and the face data corresponding to them in the face data block makes it possible to render the objects actually interactive.

Before, the purported “objects” were dot-like points, or un-clickable images in three dimensions. In the case of points, it was difficult to click, and the clickable area was unrelated to the object concerned. Moreover, on account of the associated “superposed data layer” approach, the idea was not to render the objects interactive, but to add a simplistic information layer.

By contrast, the invention makes it possible to produce a new type of map in which the interaction is possible and intuitive: if it is desired to acquire information about a subway line or about a building, or about the vegetation of a street, it suffices to click anywhere on the corresponding object.

In existing maps, the majority of the details were omitted for the sole reason that they represented a mass of information that was impossible to process in a block without excessively slowing the downloading and/or the display. Using the changeover to the “object” context, the details themselves are objects. It is therefore possible to choose the priority for displaying the objects, the most precise or ‘least useful’ details being able to be displayed last, or not be displayed at all.

Moreover, transforming the map from a collection of juxtaposed map background tiles into a world composed of individual objects generates a significant amount of new applications that were not able to be envisioned previously. For example, it becomes possible to implement building or geolocation applications that provide quick and relevant information. In the latter case, it is possible to imagine that a click on a hospital will make it possible to ascertain the specialisms that are practiced there, or else that a click on a particular building will indicate what particular care is provided and/or the rooms for the service(s) in question, to click on a particular bench to indicate that it has been vandalized, etc. And the other surrounding details may be prioritized in a lower manner so as to preserve the user experience by providing said user with information that is of primary interest to him It therefore becomes possible to introduce an enormous quantity of “layers of information” in a simple manner into maps, this previously having been impossible or inconvenient owing to the use of “layers” that were superposed and not directly linked to individualized objects.

Finally, in an operation 240, the device 2 updates the display 6 depending on the user inputs via the user interface 8. Thus, if the user changes zoom level, moves the map or interacts with one of the objects, the Web interpreter 10 calls the server 12 to obtain new data and calculates the modified data accordingly.

FIG. 3 shows an exemplary implementation of the operation 240. In an operation 300, the Web interpreter 10 determines the location data associated with the center of the map designated by the user interface 8. Thereafter, the Web interpreter 10 determines the display parameters as the angle of view and the zoom to determine a new area that has to be shown by the display.

In an operation 320, the Web interpreter 10 determines the list of the tiles corresponding to the new view determined at the operation 300, and asks the server only for those that it does not already have. In response, the server 12 returns the list of the corresponding tiles. As a variant, the server 12 may keep a list of the tiles and objects already transmitted and/or considered to be current, and directly transmit the new relevant data.

Finally, in an operation 340, the Web interpreter 10 undertakes the same operations as for the operation 220 for the newly obtained data, and updates the data that are already known and displayed if necessary.

For example, if a zoom level has been changed, finer information relating to the relief are received. The updating of the altitude of a building that is already displayed can be carried out by simply updating the elevation in the definition of the data of building faces in the face data block. Thus, for the objects that are already displayed, the updating is as lightweight as possible and allows the construction of a map in 3D with data arriving only sequentially and in disorder.

All of the optimizations presented hereinabove are made possible by the fact that the invention implements an “object” context described above, whilst this was not possible previously.

1. An interactive device, comprising a user interface for defining display requests comprising at least location data and display data, a network interface designed to issue a request for Web page data in correspondence with a display request, a memory for receiving corresponding Web page data, and a Web interpreter for displaying a Web page on the basis of Web page data, which Web interpreter comprises at least one WebGL interpreter and a 3D engine which is designed to calculate, for given Web page data comprising mapping data and object data, face data of at least one object associated with the object data, to group these face data together into data of face blocks and transmit the face block data to the WebGL interpreter for the calculation of three-dimensional display data for said at least one object while preserving a correspondence between some at least of the objects associated with the object data and the face data which correspond to them in the face block data, the Web interpreter being designed to make it possible to display Web page data on the basis of the mapping data and of the three-dimensional display data for said at least one object.

2. The device as claimed in claim 1, in which the memory stores only data of cache type.

3. The device as claimed in claim 2, in which the display data comprise zoom data, and the mapping data define a geographical environment substantially centered on a place designated by the location data, and whose extent depends on the zoom data.

4. The device as claimed in claim 3, in which the object data comprise building data comprising building location data, roof shape data, and height data.

5. The device as claimed in claim 4, in which the object data comprise relief data comprising location data, and altitude data.

6. The device as claimed in claim 5, in which the 3D engine calculates the face data by triangulation on the basis of the object data and of the zoom data.

7. The device as claimed in claim 6, in which the Web interpreter is designed to determine an identifier of object data of an object designated by a user via the user interface on the basis of the correspondence between some at least of the objects associated with the object data and the face data which correspond to them in the face block data.

8. The device as claimed in claim 7, in which the code of the 3D engine is received as display data upon the initialization of the device and/or during updates.

9. The device as claimed in claim 8, in which the 3D engine arranges the face block data in an object of Float32Array type.

10. An interactive display method comprising the following operations:
a. defining a display request comprising at least location data and display data,
b. issuing a request for Web page data in correspondence with a display request
c. receiving corresponding Web page data comprising mapping data and object data, and transmitting them to a Web interpreter comprising a 3D engine and a WebGL interpreter
d. calculating with the 3D engine face data of at least one object associated with the object data, and grouping these face data together into data of face blocks,
e. transmitting the face block data to the WebGL interpreter, while preserving a correspondence between some at least of the objects associated with the object data and the face data which correspond to them in the face block data, so as to calculate three-dimensional display data for said at least one object,
f. calling the Web interpreter with the mapping data and the three-dimensional display data for said at least one object so as to display Web page data.
